(19) United States
(12) Patent Application Publication
(10) Pub. No.: US 2008/0175986 A1
(43) Pub. Date: Jul. 24, 2008

(54) Second surface metallization

(76) Inventors: Kenneth Crouse, Newington, CT (US); Steven Abbott, Wantage (GB); Andrew Cameron, Wantage (GB)

Correspondence Address: ARTHUR G. SCHAIER;CARMODY & TORRANCE LLP, 50 LEAVENWORTH STREET, P.O. BOX 1110, WATERBURY, CT, 06721, US

(21) Appl. No.: 11/657,833

(22) Filed: Jan. 24, 2007

(51) Int. Cl. B05D 1/32; B05D 3/06

(52) U.S. Cl. 427/154; 427/299

(57) ABSTRACT

A process for selectively metallizing a transparent or translucent non-conductive substrate including the steps of 1) masking at least a portion of the front surface of the non-conductive substrate with a peelable coversheet; 2) conditioning and activating the non-conductive substrate to accept metal plating thereon; 3) removing the peelable coversheet; and 4) plating the non-conductive substrate. Thus, the portion of the non-conductive substrate masked by the peelable coversheet remains unplated such that the metal plate can be viewed through the front surface of the substrate. The non-conductive substrate may be a three-dimensional molded substrate produced from a molded plastic film.

### FIELD OF THE INVENTION

The present invention relates generally to a method of selectively metallizing a surface of a non-conductive substrate to provide a metallic appearance thereon.

### BACKGROUND OF THE INVENTION

Non-conductive materials such as glass, ceramic, and plastics may be coated with metal for decorative or functional applications. The demand for low cost metal plated plastic articles has been rapidly increasing. Metal plated articles are used in industries such as automotive, appliance, home, radio and television, etc.

For example, there have been great efforts by the automotive industry toward developing cost effective, lightweight alternatives to chrome plated metals. Plateable plastics are a desirable alternative, because they reduce the vehicle weight and thereby correspondingly increase the vehicle fuel economy, and also allow for parts consolidation within the automobile. Plastics have much greater design flexibility than metals. Plastics may be easily molded into a limitless variety of complex and contoured configurations which cannot be achieved with conventional metal stamping and forming operations. In addition, when parts are formed from plastic materials, a significant cost savings is realized over comparable parts formed from metal.

However, in order to provide non-conductive substrates with an adherent metal coating, it is necessary to sensitize the non-conductive substrates so that the metal coatings will adhere. A typical sequence of steps for metallizing non-conductive substrates includes 1) cleaning, 2) conditioning, 3) activating, and 4) electroless plating of the non-conductive substrate. Other steps may also be included depending on the metal being plated, the type of non-conductive substrate, the desired degree of adherence, and other reasons known to those skilled in the art.

In a typical processing sequence, the non-conductive substrate is first treated to clean and condition the surfaces of the substrate. The plastic parts are usually submitted to a pretreatment in order to remove any contamination such as grease or oils from the surfaces. In many instances, etching processes are also performed to roughen the surfaces so that efficient bonding to them is provided.

Following cleaning and conditioning, the surfaces are typically subjected to activation. For electroless metallization processes, activation normally consists of contacting the non-conductive substrate boards with a palladium-tin colloidal activator solution or an ionic palladium activator solution. When non-conductive materials are immersed in these palladium activator baths, the active catalyst absorbs or adheres to the non-conductive substrate.

If a colloidal tin-palladium activator is used, the presence of the protective tin can cause problems in the electroless metal deposition step (such as lengthy metal deposition times, blistering of deposited metal to substrate and contamination of the bath with tin), an acceleration step may be added between the activation step and electroless metal deposition step. A typical accelerator bath may comprise a solvent for the protective metal, being substantially a non-solvent for the catalytic metal. The result of immersion of the substrate in the accelerator bath is exposure of the catalytic surface for electroless deposition. The accelerator step is followed by water rinsing to avoid or reduce contamination of the plating bath with accelerator solution.

Next, the non-conductive materials are metal plated utilizing a metastable solution of a metal plating bath (electroless metal plating). These baths contain the metal to be deposited in the form of salts dissolved in aqueous solution as well as a reducing agent for the metal salt. The metallization step may include electroless and/or electrolytic coating to obtain the desired metallic finish. Typical metals that may be deposited by electroless plating include copper, nickel or a nickel alloy containing phosphorus and/or boron.

A wide variety of non-conductive materials are known to be suitable for plating. In the case of plastics, copolymers used may be made of acrylonitrile, butadiene and styrene and of blends thereof with other polymers such as polycarbonate. Other plastics are for example polyamides, polyolefins, polyacrylates, polyester, polycarbonate, polysulfones, polyetherimide, polyethersulfone, polytetrafluoroethylene, polyaryl ether ketone, polyimide, polyphenylene oxide as well as liquid crystal polymers.

Plated plastics are used in various high volume applications, such as for producing automotive logos and badges.

A typical process for producing automotive logos and badges includes the following steps:

1) molding the logo or badge;

2) plating the metallic layer onto the logo or badge;

3) applying a graphic design (if desired); and

4) assembling the logo or badge.

As is readily seen, the current process includes multiple manufacturing steps, which increases both the time and cost of production. Thus, it would be desirable to provide a process that produces the desired result in less time and in a more cost-effective manner. In addition, the prior art process plates the face of the non-conductive material such that the viewed portion of the plated metal is exposed to the atmosphere and is subject to damage. As a result, relatively thick metal plating must be conducted so that the plating has structural and corrosion resistance.

Typically, in the prior art, in order to perform electroless plating partially on a substrate, it was necessary to apply masking to the portion of the part which does not need plating. The masking was generally left unremoved until after electroless plating. Thus, it would be desirable to provide an improved method of masking a part to be plated.

The present invention relates to a method of selectively metallizing a non-conductive substrate to form a metallized coating on at least a portion of the non-conductive substrate. The present invention is useful to produce a variety of metallized parts in a streamlined, cost efficient manner, including parts such as wheel skins, lighting reflectors, heated mirrors, mobile phones, logos, badges and other such parts.

The process of the present invention can be used to replace the current process of plating on plastic in producing automotive badges and logos, including the steps of decal application and assembly by using a more streamlined approach that incorporates these steps.

### SUMMARY OF THE INVENTION

It is an object of the present invention to provide an improved method of forming an adherent metallic layer on a non-conductive substrate.

It is another object of the present invention to provide a cost effective process for manufacturing high volume metal plated non-conductive substrates including plastic parts. It is another object of the present invention to provide an improved process for manufacturing molded articles having an adherent metallic layer formed thereon. It is another object of the present invention to provide a streamlined process for producing metal coated plastic parts that incorporate decals or graphics.

To that end, the present invention relates generally to a process for selectively metallizing a clear or translucent non-conductive substrate comprising a front surface and a back surface, said front and back surfaces opposing each other, said process comprising the steps of:

a) masking at least a portion of the front surface of the non-conductive substrate with a removable coversheet;

b) preparing the non-conductive substrate for plating thereon by conditioning and activating the non-conductive substrate;

c) removing the removable coversheet; and

d) metal plating the back surface of the non-conductive substrate;

whereby the portion of the front surface masked by the removable coversheet remains unplated.

In another embodiment, the present invention relates to a process for producing a molded substrate with a metallic layer deposited thereon, the process comprising the steps of:

a) providing a clear or translucent plastic film having a front side and a back side;

b) masking the front side of the plastic film with a removable coversheet;

c) conditioning and activating the molded plastic film to accept plating thereon;

d) removing the removable coversheet from the molded plastic film; and

e) plating the molded plastic film by electroless plating;

whereby the front side of the molded plastic film remains unplated and the backside of the molded plastic film has an adherent metal plated layer thereon; and thereafter encapsulating the adherent metal plated layer with plastic.

### DETAILED DESCRIPTION OF THE PREFERRED EMBODIMENTS

The present invention relates generally to a process for selectively metallizing a clear or translucent non-conductive substrate comprising a front surface and a back surface, said front and back surfaces opposing each other, said process comprising the steps of:

a) masking at least a portion of the front surface of the non-conductive substrate with a removable coversheet;

b) preparing the non-conductive substrate for plating thereon by conditioning and activating the non-conductive substrate;

c) removing the removable coversheet; and

d) metal plating the back surface of the non-conductive substrate;

whereby the portion of the front surface masked by the removable coversheet remains unplated such that the metal plate can be viewed through the front surface of the substrate.

The process of the present invention can provide a nickel finish that exhibits an appearance similar to a chrome finish. The present invention is useful for example in providing a metallic finish on three-dimensional parts that have shape complexity. For example, the present invention provides a beneficial result on three-dimensional parts.

In addition, the inventors of the present invention have also found it beneficial to expose the non-conductive substrate to UV radiation prior to the metal plating step. The inventors have found that this exposure to U.V. radiation increases the adhesion of the metal plate to the substrate.

The present invention also relates to a process for producing a molded substrate with a metallic layer deposited thereon, the process comprising the steps of:

a) providing a plastic film having a front side and a back side;

b) masking the front side of the plastic film with a removable coversheet;

c) molding the plastic film into a three-dimensional shape;

d) conditioning and activating the molded plastic film to accept plating thereon;

e) removing the removable coversheet from the molded plastic film; and

f) plating the molded plastic film by electroless plating;

whereby the front side of the molded plastic film remains unplated and the backside of the molded plastic film has an adherent metal plated layer thereon such that the metal film can be viewed through the front side of the plastic film.

In this embodiment, a typical sequence of steps is as follows:

1) A 200 μm thick polycarbonate film is laminated with a removable (i.e., peelable) coversheet on one side of the film.

2) The polycarbonate film is sensitized and printed or screened with a desired graphic (if required) on the side of the film not covered by the coversheet.

3) The film is molded into a desired three-dimensional shape for metallization.

4) Next, the film is processed through a four-stage metallization line that includes the steps of conditioning, activating, accelerating, and electroless plating. Prior to the electroless plating step but after conditioning, activating and accelerating, the peelable coversheet is removed from the polycarbonate film.

An example of the four-stage metallization line includes the steps of:

1) Conditioning (2 minutes);

2) Activating (2 minutes);

3) Accelerating (2 minutes); and

4) Electroless nickel plating (4 minutes).

5) The plated part is baked for a period of time (15 minutes) at a temperature of 100° C.

6) The parts are provided to an injection molding machine or otherwise to encapsulate or backfill the plated parts with a selected plastic material.

While the example uses a polycarbonate film, the process of the invention is not limited to this material. Other non-conductive substrates include acrylonitrile-butadiene-styrene resins, nylon, polyethylene terapthalate, polyethylene, polypropylene, polyolefins, polymethylmethacrylate, and combinations thereof. Other non-conductive substrates that are suitable for selective metallization may also be used in the process of the present invention.

In a preferred embodiment, the process of the invention includes the step of molding the substrate to create a desired pattern having a front side and a back side. In this instance, the peelable coversheet is applied to one side of the molded article (i.e., the front side) and the substrate is metallized on the back side of the substrate. Prior to metallization, the peelable coversheet is removed from the molded article. The goal here is to allow plating to proceed on the back side of the substrate but not on the front side of the substrate such that the metal coating can be viewed looking through the front side of the substrate. This goal can be alternately achieved without the use of a peelable coversheet or mask on the front surface of the substrate by selectively applying activator to the back surface of the substrate without applying activator to the front surface. This can be accomplished by utilizing a selective means of activator application (as opposed to immersion of the entire substrate) such as selectively printing the activator on the back surface of the substrate using ink jet printing, screen printing or selective coating.

In addition, the means for molding the article is not critical to the present invention and various means known for molding the article may be used, such as molding in a die. Other means of forming the substrate include vacuum forming, Niebling process or hydroforming. The important aspect here is imparting a desired three dimensional shape to the substrate. Hereafter this shape imparting process will be collectively referred to as “forming”. It is generally preferred that the plating step be performed by electroless plating, and the electroless plating metal may typically be selected from the group consisting of nickel, copper, cobalt, phosphorus, and combinations of one or more of the foregoing.

The process of the invention also typically includes the step of backfilling the plated substrate with a non-conductive material to encase the plated substrate and prevent delamination of the metallized layer. Typically, the part is backfilled with polycarbonate, nylon, ABS or other resin material. The backfilling or encasing step may be performed by returning the plated substrate to the injection molding apparatus to encase the plated substrate in the desired fashion.

In another preferred embodiment of the invention, the substrate is exposed to UV radiation prior to the metallization step. Exposure to U.V. radiation prior to plating has been found to increase the adhesion of the plated metal to the plastic part.

It is also possible to provide different effects of the metallized plastic by using colored plastics and different metals for the plating step. For example, the plastic may be tinted yellow and electroless nickel used as the plating metal to provide a gold effect. In other embodiments, it may be preferable to use a transparent substrate for electroless plating and/or for encapsulating the plated substrate. The important aspect here is that the metal is plated onto the back surface of the plastic film such that the metal is viewed through the front surface of the plastic film in the normal operation of the part. This process allows the metal to be viewed through the plastic surface. The plated metal is thereby protected by the plastic film and as a result degradation is reduced and thinner metal coatings can effectively be used.

It is also possible to provide different effects by including a step of applying a graphic or a logo to the portion of the non-conductive substrate that will be metallized prior to molding the substrate. In this regard graphic designs can be created by printing inks or resins on the front or back surface of the plastic substrate. Clear or colored transparent or translucent inks or resins may be printed on the substrate to create selective tinting or an opaque design. Thus, for example, yellow transparent or translucent ink may be printed on the back surface of the substrate in a selective manner, such as stripes, before plating nickel onto the back surface, thereby creating a striped gold/silvery appearance when viewed through the front surface of the substrate. In the alternative, an opaque ink may be selectively printed on the back surface of the substrate before plating, thereby creating a desired graphic design encompassed by a metallic appearance when viewed through the front surface of the substrate. Lastly, if printing of the back face occurs after activation, metal plating will not proceed on the printed area. Thus if a clear ink is printed on the back surface after activation, this will create a selective unplated area which is clear in appearance encompassed by metallic appearance when viewed through the front face of the substrate.

One benefit of the present invention is that it can incorporate a complex graphic design. Thus, the present invention is usable, for example, to manufacture automotive logos and badges. It is further possible to incorporate graphics, including color graphics into the design. As discussed above, the present invention is most useful for metallizing logos and badges having simple shapes and minimal flat areas. Because of the streamlined nature of the process of the present invention, the process can be used in high volume applications.

The present invention is also directed to articles made by the process of the invention.

While the invention has been particularly shown and described with respect to preferred embodiments thereof, it will be understood by those skilled in the art that changes in form and details may be made therein without departing from the scope and spirit of the invention.

What is claimed is:

1. A process for selectively metallizing a clear or translucent non-conductive substrate comprising a front surface and a back surface, said front surface and back surface opposing each other, said process comprising the steps of:
a) masking at least a portion of the front surface of the non-conductive substrate with a removable coversheet;
b) conditioning and activating the non-conductive substrate to accept metal plating thereon;
c) removing the coversheet; and
d) plating the back surface of the non-conductive substrate;
whereby the at least the portion of the surface masked by the coversheet remains unplated such that metal plate can be viewed through the front surface of the substrate.

2. The process according to claim 1, further comprising baking the substrate after the plating step.

3. The process according to claim 1, wherein the non-conductive substrate is selected from the group consisting of acrylonitrile butadiene styrene resin, polycarbonate resin, nylon, polyethylene terapthalate, polyethylene, polypropylene, polyolefins, polymethylmethacrylate, and combinations of one or more of the foregoing.

4. The process according to claim 1, further comprising the step of forming the substrate to create a three-dimensional substrate.

5. The process according to claim 4, wherein the molded substrate is formed at least in part by injection molding.

6. The process according to claim 1, wherein the plating step comprises electroless plating.

7. The process according to claim 6, wherein the electroless plating metal is selected from the group consisting of nickel, copper, cobalt, phosphorus, and combinations of one or more of the foregoing.

8. The process according to claim 1, further comprising the step of backfilling the plated substrate with a non-conductive material.

9. The process according to claim 8, wherein the non-conductive material used for backfilling the plated substrate is selected from the group consisting of ABS resins, polycarbonate resins, nylon, and combinations of one or more of the foregoing.

10. The process according to claim 1, comprising the step of exposing the substrate to UV radiation prior to the plating step.

11. The process according to claim 3, wherein the non-conductive substrate is tinted with color.

12. The process according to claim 11, wherein the non-conductive substrate is tinted yellow and the plating step comprises electroless nickel plating.

13. The process according to claim 3, wherein the non-conductive substrate is transparent.

14. The process according to claim 8, wherein the non-conductive substrate and the material used for backfilling the non-conductive substrate are transparent.

15. The process according to claim 4 comprising the step of applying a graphic on the back side of the non-conductive substrate that prior to molding the substrate.

16. A product made by the process of claim 1.

17. A process for producing a molded substrate with a metallic layer deposited thereon, the process comprising the steps of:
a) providing a plastic film having a front side and a back side;
b) masking the front side of the plastic film with a removable coversheet;
c) molding the plastic film into a three-dimensional shape;
d) conditioning and activating the molded plastic film to accept plating thereon;
e) removing the removable coversheet from the molded plastic film; and
f) plating the molded plastic film by electroless plating;
whereby the front side of the molded plastic film remains unplated and the backside of the molded plastic film has an adherent metal plated layer thereon such that the metal plated layer can be viewed through the front side of the substrate.

18. The process according to claim 17, further comprising the step of backfilling the molded plastic film with a non-conductive material to substantially encase the molded film and the metal plated layer.

19. The process according to claim 18, wherein the non-conductive material used for encasing the molded film is selected from the group consisting of ABS resins, polycarbonate resins, nylon, polyethylene terapthalate, polyethylene, polypropylene, polyolefins, polymethylmethacrylate, and combinations of one or more of the foregoing.

20. A process according to claim 18, wherein a graphic design is printed on the back side of the substrate prior to plating.

21. A molded product made by the process of claim 18.

22. A process for selectively metallizing a clear or translucent non-conductive substrate comprising a front surface and a back surface, said front surface and back surface opposing each other, said process comprising the steps of:
(a) selectively activating at least a portion of the back surface to accept metal plating thereon;
(b) plating the back surface;
whereby at least a portion of the front surface remains free of metal plating and at least a portion of the back surface is plated with metal such that metal plate can be viewed through the front surface of the substrate.

23. The process according to claim 22, further comprising baking the substrate after the plating step.

24. The process according to claim 22, wherein the non-conductive substrate is selected from the group consisting of acrylonitrile butadiene styrene resin, polycarbonate resin, nylon, polethylene terapthalate, polyethylene, polypropylene, polyolefins, polymethylmethacrylate, and combinations of one or more of the foregoing.

25. The process according to claim 22, further comprising the step of molding the substrate to create a three-dimensional substrate.

26. The process according to claim 25, wherein the molded substrate is formed at least in part by injection molding.

27. The process according to claim 22, wherein the plating step comprises electroless plating.

28. The process according to claim 27, wherein the electroless plating metal is selected from the group consisting of nickel, copper, cobalt, phosphorus, and combinations of one or more of the foregoing.

29. The process according to claim 22, further comprising the step of backfilling the plated substrate with a non-conductive material.

30. The process according to claim 29, wherein the non-conductive material used for backfilling the plated substrate is selected from the group consisting of ABS resins, polycarbonate resins, nylon, polyethylene terapthalate, polyethylene, polypropylene, polyolefins, polymethylmethacrylate, and combinations of one or more of the foregoing.

31. The process according to claim 22, comprising the step of exposing the substrate to UV radiation prior to the plating step.

32. The process according to claim 22, wherein the non-conductive substrate is tinted with color.

33. The process according to claim 32, wherein the non-conductive substrate is tinted yellow and the plating step comprises electroless nickel plating.

34. The process according to claim 24, wherein the non-conductive substrate is transparent.

35. The process according to claim 29, wherein the non-conductive substrate and the material used for backfilling the non-conductive substrate are transparent.

36. The process according to claim 22 comprising the step of applying a graphic on the back side of the non-conductive substrate that prior to molding the substrate.
